(19) United States
(12) Patent Application Publication
(10) Pub. No.: US 2020/0302771 A1
(43) Pub. Date: Sep. 24, 2020

(54) SYSTEM FOR POWER OUTAGE NOTIFICATIONS

(71) Applicant: Paul Modiano, Montclair, NJ (US)

(72) Inventor: Paul Modiano, Montclair, NJ (US)

(21) Appl. No.: 16/894,099

(22) Filed: Jun. 5, 2020

(51) Int. Cl. G08B 21/18

(52) U.S. Cl. CPC G08B 21/185; H04W 84/12

(57) ABSTRACT

The present invention is directed to a system for notifying power outage, the system comprising: a control unit configured to connect to a network for sending a notification; a utility power sensor configured to detect a utility power outage, the utility power sensor electrically connected to the control unit; and a generator power sensor configured to detect a generator power output, the generator power sensor electrically connected to the control unit.

### FIELD OF INVENTION

The present invention relates to a system and method for notifying a power outage.

### BACKGROUND

Water expands upon freezing. This expansion of water puts pressure on the container containing the water. In case, there is no space for the water to expand, the pressure exerted may cause the container to burst. This is the cause of the bursting of water pipes in cold climates. In extremely cold climates, water in the pipes starts freezing and expands. The expansion of water in the pipes causes the pipes to burst. Freezing and bursting of water pipes are common in the countries having extremely cold climates and the countries having seasonal cold climates. The bursting of pipes can be quite expensive for the property owner, besides the frustration of repairs and chances of water flooding in the house. The burst pipes are the most common cause of property damage in cold climates.

Keeping the water pipes warm during winters can prevent ice formation in the pipes. To keep the water pipes warm, gas or oil powered furnaces are generally used, and electrical heaters are sometimes used to keep the house warm. Because oil or gas furnaces still require electricity to operate and electrical heaters depend solely on electricity, any power outage can result in their failure and can result in the freezing of the water pipes. Power outages are common in bad weather and the failure of the heaters resulting in freezing of the water pipes could prove very expensive. A backup power source, such as a generator is used to overcome power outages, but the generators can also fail. Moreover, during a long power outage, the fuel of the generator may get consumed. Since the changeover of the power from utility power to the generator is generally automatic, the owner may know about the failure of the generator only when it is too late. Thus, a need is appreciated for the timely notification of power outages and generator failures.

### SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The principal objective of the present invention is therefore directed to a system and method for monitoring a power supply.

It is another objective of the present invention that the system can detect the power outage.

It is still another objective of the present invention that the system can detect a failure of the generator.

It is a further objective of the present invention that the system can provide timely notification about the failure.

It is still further objective of the present invention that the system is non-invasive and could be installed independently of the generator.

It is an additional objective of the present invention that the system is universally compatible with all standby generators from different manufacturers.

It is yet a further objective of the present invention that the system is economic to manufacture.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the system, according to an embodiment of the present invention.

FIG. 2 is a flow chart illustrating the method, according to an embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

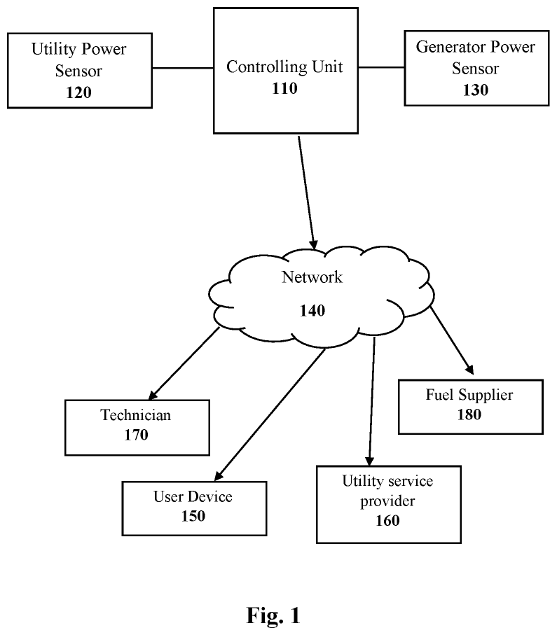

The present invention is directed to a system and method for detecting a power outage and providing timely notification of the power outage. Referring to FIG. 1, the system 100, according to the present invention, comprises a control unit 110 connected to a utility power sensor 120 and a generator power sensor 130. The control unit 110 can be a compact computing device with network connectivity. The control unit 110 can be connected wirelessly to a network 140, wherein the network 140 can be a cellular network, Wi-Fi network, and/or the Internet. The control unit 110 can send the notification, through the network 140 to a user device 150, a utility service provider 160, a technician 170, and/or a fuel supplier 180.

The sensors 120 and 130 according to the present invention can non-invasively detect the current flow in the electrical wire. The sensors 120 and 130 comprise an inertial copper coil that can be wrapped around the electrical wire to detect the flow of the alternating current in the electrical wire. Both sensors can be electrically connected to the control unit 110. The utility power sensor 120 can be coupled to wire only receiving the utility power. The utility power sensor 120 can detect any utility power outage. On the other hand, the generator power sensor 130 can be coupled to an electrical wire receiving generator output. The generator acts as a backup to keep the HVAC system (including an electric furnace or baseboard heaters) running for keeping the house warm. The generator power sensor 130 can detect any failure of the generator. Besides the problem of technical failures, during long power outages, the generator may run out of the fuel. Thus, bringing the heating systems to a halt. Such problems of power outages and failure of generators are unavoidable, but a timely notification of the power outage or the generator failure may allow a quicker remedy of the problem.

The system could directly notify the utility service provider about the power outage. Sometimes the power service provider knows of the power outage when the consumer calls to complain about the power outage. This can be particularly important when only a single consumer is affected by the power outage. The utility service provider can be notified by a text message, a voice message, E-mail, or any other method feasible or advised by the utility service provider. The utility service provider can acknowledge the notification by sending a message to the user. This will ensure that the utility service provider has been informed about the power outage. Furthermore, the user can also be informed by the system of the present invention that the utility service provider has been notified about the power outage. For example, if the utility service provider has been notified through an email, a copy of the email can also be sent to the user at his email id. This saves the user from the trouble of himself notifying the utility service provider about the power outage. Moreover, sooner the utility service provider is informed, sooner they can remedy the power outage.

In case of failure of the generator, the system according to the present invention can directly notify a technician about the failure of the generator. The technician can be notified by a text message, a voice message, E-mail, or any other method feasible or advised by the technician. The technician can acknowledge the notification by sending a message to the user. This will ensure that the technician has been informed about the failure of the generator. Furthermore, the user can also be informed by the system of the present invention that the technician has been notified about the generator failure. For example, if the technician has been notified through an email, a copy of the email can also be sent to the user at his email id. This saves the user from the trouble of himself notifying the technician about the failure of the generator. Moreover, sooner the technician is informed, sooner they can remedy the failure of the generator.

In case, the power outage cannot be resolved for a long period, the generator may run out of fuel. The system according to the present invention can monitor the time the generator has been running. A threshold can be configured into the system, and if the generator has been running for a period that exceeds the predefined threshold, the system can notify the user and the fuel supplier. The fuel supplier can be notified by a text message, a voice message, E-mail, or any other method feasible or advised by the fuel supplier. The fuel supplier can acknowledge the notification by sending a message to the user. This will ensure that the fuel supplier has been requested to refill the fuel. Furthermore, the user can also be informed by the system of the present invention that the fuel supplier has been notified about the fuel refill. For example, if the fuel supplier has been notified through an email, a copy of the email can also be sent to the user at his email id. This saves the user from the trouble of himself requesting the fuel supplier to refill the fuel. Moreover, sooner the fuel supplier is informed, sooner they can refill the fuel.

In all the above cases, the user can be promptly notified about the power outage, generator failure, or consumption of fuel by the generator. All such notification can be time-stamped, and the system can keep track of the duration between such notifications. The system also sends further notifications and follow-up to the user. For example, the user can be informed that the power has been restored, or the generator has been repaired, or the fuel of the generator has been refilled. These notifications and the frequency of these notifications can be configured by the user into the system.

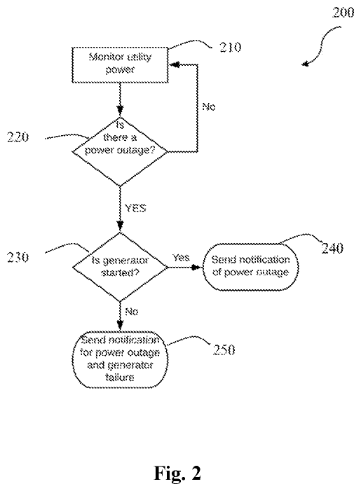

FIG. 2 shows an embodiment of a method 200, according to an embodiment of the present invention. At step 210, power from the utility service provider can be monitored by the system of the present invention. At step 220, any utility power outage can be determined by the system. In case, there is no power outage, the system continues to monitor the utility power supply. However, if any, power outage is detected, the system, at step 230 checks if the generator has been started. In case, the generator has been started, the system can send a notification about power failure, at step 240. However, if the generator could not be started, maybe due to technical failure or any other reasons, the system can send a notification both about the power outage and the failure of the generator, at step 250. The notification at step 250 can be flagged by the system to indicate the urgency of the issue.

In one embodiment, the control unit can be a Linux-based computing device called a Raspberry Pi configured with a USB cellular data modem for connecting to a cellular network. The Raspberry Pi computing device can send text messages through the cellular network. The Raspberry Pi computing device can receive input from the utility power sensor and the generator power sensor. The Raspberry Pi computing device can be further configured with circuitry for adapting electrical signals from the sensors to digital signals that can be further processed by the Raspberry Pi computing device. In one case, the circuitry can be an analog to digital converter. The control unit can be powered by the battery of the generator. Alternatively, the system can further include a battery for powering the control unit and the sensors. The battery can be a lithium-ion battery coupled to the control unit. The control unit can be connected to an email server for sending emails. Similarly, the control unit can be connected to an SMS text server, such as Twilio for sending text messages.

The present invention is particularly advantageous being non-invasive, which can be installed independently of the generator i.e. it can be installed with any type of generator or power source. Being non-invasive makes the system of the present invention universally compatible with all standby generators from all manufacturers. Thus, the system of the present invention is economical and easy to install.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for notifying power outage, the system comprising:
a control unit configured to connect to a network for sending a notification;
a utility power sensor configured to detect a utility power outage, the utility power sensor electrically connected to the control unit; and
a generator power sensor configured to detect a generator power output, the generator power sensor electrically connected to the control unit.

2. The system of claim 1, wherein the network is a Wi-Fi network.

3. The system of claim 1, wherein the network is a cellular network.

4. The system of claim 1, wherein the network is an internet network.

5. The system of claim 1, wherein the notification is selected from a group consisting of a text message, a voice message, or an email.

6. The system of claim 1, wherein the control unit comprises a cellular modem for connecting to a cellular network.

7. The system of claim 1, wherein each of the utility power sensor and the generator power sensor comprises an inertial copper coil configured to be wrapped around an electrical wire.

8. A method of notifying a power outage, the method comprising:
providing a system, the system comprising:
a control unit configured to connect to a network for sending a notification,
a utility power sensor configured to detect a utility power outage, the utility power sensor electrically connected to the control unit, and
a generator power sensor configured to detect a generator power output, the generator power sensor electrically connected to the control unit;
determining the utility power outage;
upon identification of the utility power outage, determining a status of the generator.

9. The method of claim 8, wherein, upon determining the status of the generator, if the generator is running, the method further comprises a step of sending a notification of power outage to one or more receivers.

10. The method of claim 9, further comprises:
determining, if the generator has been running for a period that exceeds a predetermined threshold;
upon determining that the generator is running for the period that exceeds the predetermined threshold; sending the notification to a user and a fuel supplier.

11. The method of claim 9, wherein the one or more receivers comprises a user and a utility service provider.

12. The method of claim 10, wherein the predetermined threshold can be configured into the controlling unit, the predetermined threshold is based on amount of a fuel of the generator.

13. The method of claim 8, wherein, upon determining the status of the generator, if the generator is not running, the method further comprises a step of sending a notification of power outage and generator failure to one or more receivers.

14. The method of claim 13, wherein the notification of power outage is sent to the user and the utility service provider, and wherein the notification of generator failure is sent to the user and a technician.

15. The method of claim 8, wherein the control unit is configured with a cellular modem, and the network is a cellular network.

16. The method of claim 8, wherein the network is a Wi-Fi network.

17. The method of claim 8, wherein the network is an internet network.

18. The method of claim 8, wherein each of the utility power sensor and the generator power sensor comprise an induction copper coil configured to be wrapped around an electrical wire.
